(19) United States
(12) Patent Application Publication
(10) Pub. No.: US 2016/0119221 A1
(43) Pub. Date: Apr. 28, 2016

(54) TRANSMISSION DEVICE AND METHOD FOR ESTABLISHING PATH IN MULTILAYER NETWORK

(71) Applicant: FUJITSU LIMITED, Kawasaki-shi (JP)

(72) Inventor: Yuji Tochio, Yokohama (JP)

(21) Appl. No.: 14/847,274

(22) Filed: Sep. 8, 2015

(30) Foreign Application Priority Data
Oct. 27, 2014 (JP) 2014-218714

(51) Int. Cl. H04L 12/751; H04J 3/16; H04Q 11/00; H04L 12/721

(52) U.S. Cl. CPC H04L 45/02; H04L 45/26; H04J 3/1652; H04Q 11/0066; H04Q 2011/0073

(57) ABSTRACT

A transmission device is located between a first node and a second node in a multi-layer network in which a path message is transmitted from the first node to the second node and a response message corresponding to the path message is transmitted from the second node to the first node. A transmission device includes: an upper layer switch that processes traffic in the upper layer; a lower layer switch that processes traffic in a lower layer; and a signaling processor that processes the path message and the response message. The signaling processor transmits a message for establishing a path in the lower layer to a node represented by node information added to the response message received from an adjacent node on a downstream side when the lower layer switch is not connected to a lower layer switch of an adjacent node on an upstream side.

### CROSS-REFERENCE TO RELATED APPLICATION

This application is based upon and claims the benefit of priority of the prior Japanese Patent Application No. 2014-218714, filed on Oct. 27, 2014, the entire contents of which are incorporated herein by reference.

### FIELD

The embodiments discussed herein are related to a transmission device and a method for establishing a path in a multilayer network.

### BACKGROUND

In recent years, with advances in the optical transmission technology and the packet transmission technology, transmission devices that support transmission in a plurality of different network layers or communication layers (referred to as layers hereinafter) have been put into practical use. A transmission device of this type is provided with for example a switching function of an optical layer and a switching function of a packet layer. An optical layer is realized by an OTN (Optical Transport Network). A packet layer is placed higher than the optical layer. The transmission device of this type can multiplex paths/connections in a packet layer into paths/connections in an optical layer. By using that transmission device, a connection of a large capacity and with high transmission efficiency is provided. In addition, it is possible to flexibly establish transmission routes of traffic.

FIG. 1 illustrates an example of data transmission in a multi-layer network. In this example, each of the respective transmission devices #1 through #4 is provided with switch SW1 that processes a signal of the optical layer and switch SW2 that processes a signal of the packet layer. The optical layer is realized by an OTN. The path for transmitting data from a path ending point 1 to a path ending point 2 is established on for example the packet layer.

Switch SW1 in transmission device #1 receives an OTN frame (ODU (Optical channel Data Unit) for example) transmitted from the path ending point 1. In transmission device #1, switch SW1 guides the received frame to switch SW2. In this process, the received frame is divided into packets. Switch SW2 refers to path information set in advance, and identifies the destination of the packets. Then, switch SW1 transmits, in accordance with the destination identified by switch SW2, an OTN frame for storing the packets. Similarly to transmission device #1, transmission devices #2 through #4 respectively process traffic by using switches SW1 and switches SW2. As a result, data transmitted from the path ending point 1 is transmitted to the path ending point 2 via transmission devices #1 through #4.

Related arts are described in Japanese Laid-open Patent Publication No. 2003-324465 and Japanese Laid-open Patent Publication No. 2010-45439.

As described above, a path is established by an upper layer in a multi-layer network. Thus, signals transmitted in a lower layer are processed by the switching function of an upper layer in each transmission device, and process delay occurs.

This problem may be solved when it is possible to omit switching processes in an upper layer and to conduct switching only in a lower layer. For example, in FIG. 2, it is assumed that transmission device #3 can forward a signal between transmission device #2 and transmission device #4 without using switch SW2. In other words, it is assumed that cut-through (or off-road) is conducted between transmission device #2 and transmission device #4. In such a case, process delay is reduced in transmission device #3, and thus transmission delay between the path ending point 1 and the path ending point 2 is also reduced.

However, in order to realize the above cut-through transmission, the user or the network administrator manually configures the setting of switches. In other words, in order to realize cut-through transmission on a path that is to be established, complicated operations are to be conducted by the user or the network administrator.

### SUMMARY

According to an aspect of the embodiments, a transmission device is located between a first node and a second node in a multi-layer network in which a path message for establishing a path in an upper layer is transmitted from the first node to the second node and a response message corresponding to the path message is transmitted from the second node to the first node. The transmission device includes: an upper layer switch that processes traffic in the upper layer; a lower layer switch that processes traffic in a lower layer; and a signaling processor that processes the path message and the response message. The signaling processor adds node information representing a node at which the transmission device is provided to the response message received from an adjacent node on an downstream side and forwards the response message to an adjacent node on an upstream side when node information is not added to the received response message and the lower layer switch is connected to a lower layer switch of the adjacent node on an upstream side. The signaling processor forwards the response message received from an adjacent node on a downstream side to an adjacent node on an upstream side when node information is added to the received response message and the lower layer switch is connected to a lower layer switch of the adjacent node on an upstream side. The signaling processor transmits a message for establishing a path in the lower layer to a node represented by node information added to the response message received from an adjacent node on a downstream side when the node information is added to the received response message and the lower layer switch is not connected to a lower layer switch of an adjacent node on an upstream side.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of data transmission in a multi-layer network;

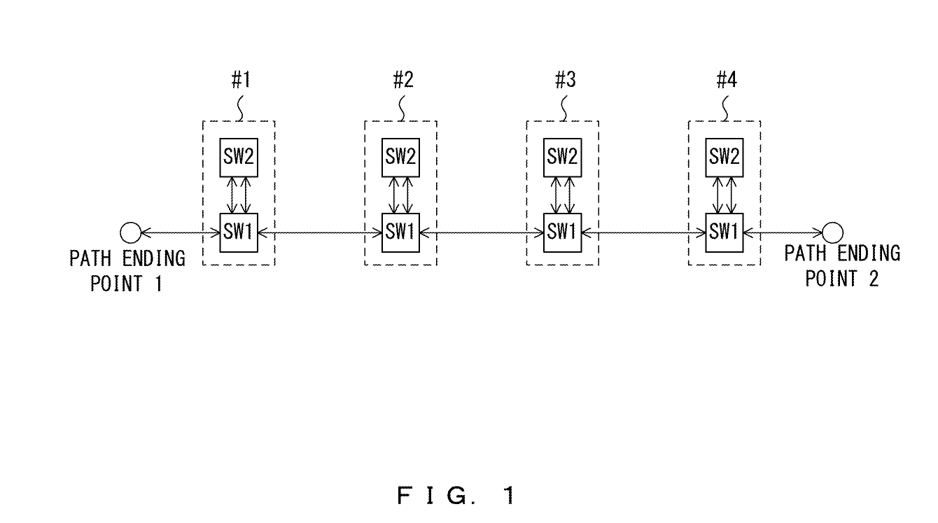

FIG. 2 illustrates an example of cut-through transmission;

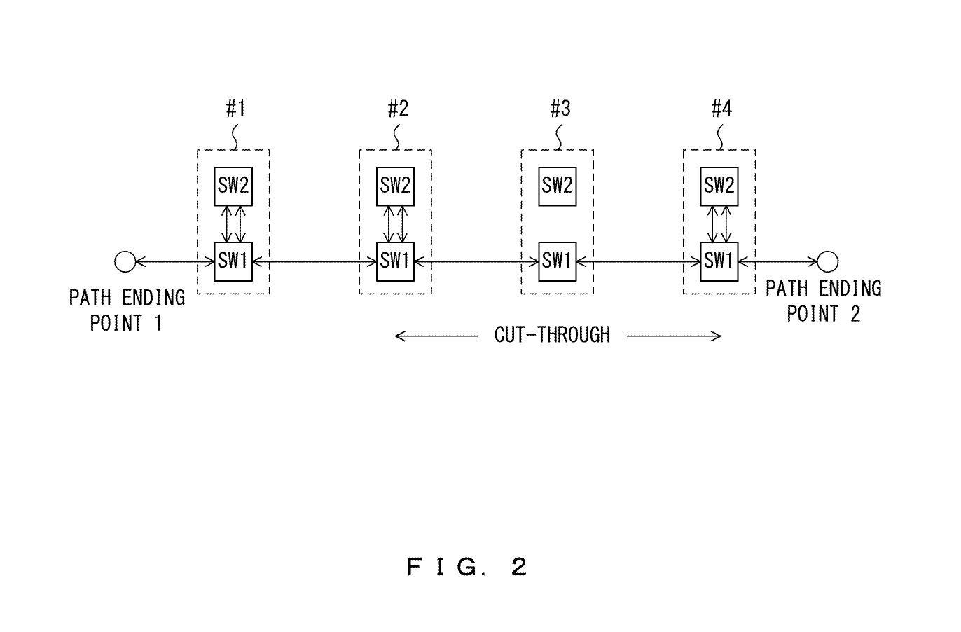

FIG. 3 illustrates an example of a path providing method according to a first embodiment;

FIG. 4 illustrates an example of a configuration of a transmission device;

FIGS. 5A-5F illustrate examples of node information of their own nodes;

FIGS. 6A-6F illustrate examples adjacent node information;

FIG. 7 is a flowchart illustrating an example of a process of a transmission device according to the first embodiment;

FIG. 8 is a flowchart illustrating another example of a process of a transmission device according to the first embodiment;

FIG. 9 illustrates an example of a path providing method according to a second embodiment;

FIG. 10 is a flowchart illustrating an example of a process of a transmission device according to the second embodiment;

FIG. 11 is a flowchart illustrating another example of a process of a transmission device according to the second embodiment; and

FIG. 12 illustrates a path establishing method according to another embodiment.

### DESCRIPTION OF EMBODIMENTS

### First Embodiment

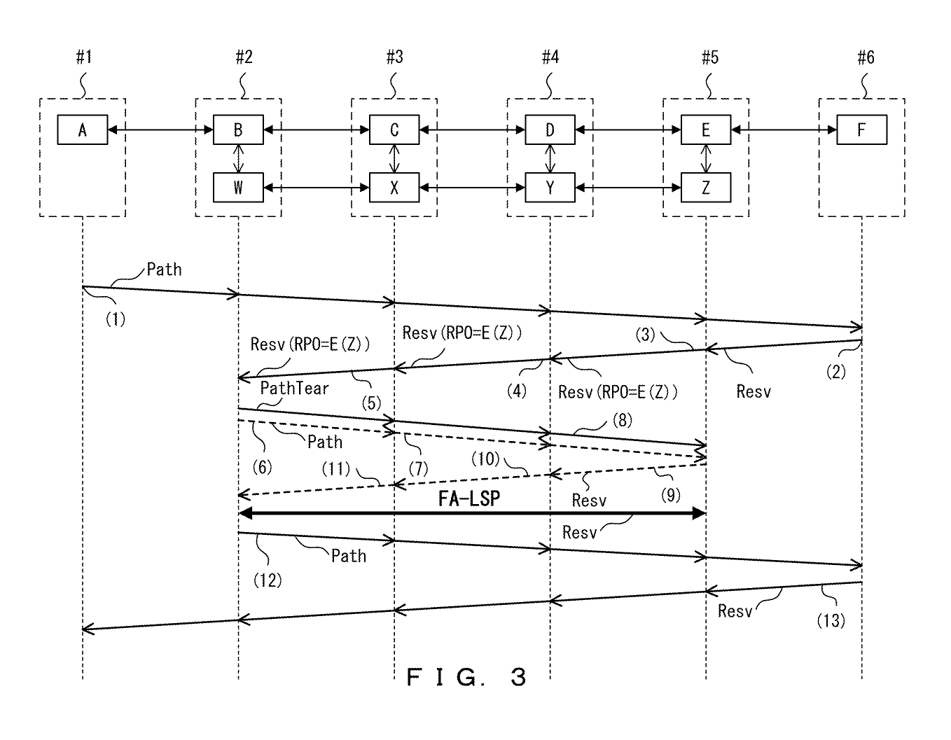

FIG. 3 illustrates an example of a path providing method according to a first embodiment of the present invention. In the example illustrated in FIG. 3, nodes #1 through #6 are respectively provided with transmission devices. In the description below, the transmission device provided at node #i (i=1 through 6) will be referred to as transmission device #i. In other words, the network system includes transmission devices #1 through #6. However, the network system may include other transmission devices in addition to transmission devices #1 through #6.

The network system illustrated in FIG. 3 supports transmission in a plurality of different layers. In the descriptions below, the packet layer is an example of an upper layer and the optical layer is an example of a lower layer.

Transmission devices #1 through #6 are respectively provided with packet layer switches that process traffic in the packet layer. “A” through “F” illustrated in FIG. 3 represent the packet layer switches provided to transmission devices #1 through #6, respectively. Paths in the packet layer are realized by LSP (Label Switched Path) of MPLS (Multi-Protocol Label Switching) in this example. Specifically, a label is added to a packet transmitted in the network system. The packet layer switches identify the forwarding destination of a received packet in accordance with the label added to the received packet. Accordingly, in the packet layer switch of each node, information representing a path (such as label information) is configured before the start of communications.

In addition to the packet layer switches, transmission devices #2 through #5 respectively include optical layer switches that process traffic in the optical layer. “W” through “Z” illustrated in FIG. 3 represent the optical layer switches provided to transmission devices #2 through #5, respectively. Paths on this layer are realized by an OTN (Optical Transport Network) in this example. The optical layer switches identify a port for outputting an OTN frame (ODU (Optical channel Data Unit) for example) in accordance with a port at which the received OTN frame arrived. Accordingly, in the optical layer switch of each node, routing information representing correspondence relationships between input ports and output ports is configured.

Transmission devices #2 through #5 respectively have a function of extracting a packet from a received OTN frame. In addition, transmission devices #2 through #5 respectively have a function of inserting a packet into an OTN frame to be transmitted.

In the network system illustrated in FIG. 3, transmission device #1 establishes a path for transmitting data to transmission device #6. In the following descriptions, it is assumed that signaling is conducted based on RSVP-TE (Resource Reservation Protocol Traffic Engineering), which is employed by MPLS. Note that in the signaling sequence illustrated in FIG. 3, the solid arrows represent transmission of signaling messages in the packet layer and the dashed-line arrows represent transmission of signaling messages in the optical layers. Also, a path established in the optical layer may be referred to as a “connection”.

(1) Transmission device #1 starts signaling in the packet layer. Specifically, transmission device #1 generates a message for establishing a path (referred to as a Path message hereinafter) between transmission device #1 and transmission device #6 (LSP in this example). This Path message includes a Label Request Object and an ERO (Explicit Route Object). A label request requests the assignment of a label. An ERO identifies a path from the head end node to the tail end node. In this example, “ERO=#2, #3, #4, #5, #6” is added to a Path message. Transmission device #1 transmits this Path message toward transmission device #6. By so doing, this Path message is forwarded to transmission device #6 via transmission devices #2, #3, #4 and #5.

(2) Transmission device #6 transmits, toward transmission device #1, a response message (referred to as a Resv message hereinafter) in response to the Path message transmitted from transmission device #1. This Resv message includes label information representing a label value corresponding to a path from transmission device #5 to transmission device #6. Also, the Resv message includes an RRO (Record Route Object) representing anode on the route on which the path is established. However, in this example, node information for identifying a node that can perform cooperative operations between the packet layer switch and the optical layer switch is set in the RRO. In this example, transmission device #6 does not have an optical layer switch and thus is not capable of performing cooperative operations between the packet layer and the optical layer, and accordingly node information representing transmission device #6 is not set in the RRO in a Resv message transmitted from transmission device #6.

(3) Upon receiving the Resv message from transmission device #6, transmission device #5 executes a process defined by RSVP-TE. Specifically, transmission device #5 updates the label information of the Resv message. In this process, a label value corresponding to a path from transmission device #4 to transmission device #5 is given to the label information.

In addition to the update of the label information, transmission device #5 processes the RRO of the Resv message. Specifically, transmission device #5 decides whether or not node information is set in the RRO of the received Resv message. In this example, node information is not set in the RRO of the Resv message transmitted from transmission device #6. In addition, transmission device #5 decides whether or not cooperative operations between the packet layer switch and the optical layer switch can be performed in transmission device #5. In this example, transmission device #5 is provided with optical layer switch Z, and cooperative operations between packet layer switch E and optical layer switch Z can be performed in transmission device #5. Further, transmission device #5 decides whether or not a connection can be established between the optical layer switch of transmission device #5 and an optical layer switch of a node that is adjacent to transmission device #5 on the upstream side (i.e., on the side of the head end node). In this example, it is assumed that a connection can be established between optical layer switch Z in transmission device #5 and optical layer switch Y in transmission device #4. In such a case, transmission device #5 sets, in the RRO of the Resv message, node information indicating that cooperative operations between the packet layer switch and the optical layer switch can be performed in transmission device #5. Transmission device #5 is provided with packet layer switch E and optical layer switch Z. Accordingly, the node information set in the RRO in transmission device #5 is referred to as “E(Z)”. Then, transmission device #5 transmits a Resv message to which node information “E(Z)” is added to transmission device #4.

(4) Upon receiving the Resv message from transmission device #5, transmission device #4 executes a process defined by RSVP-TE. Specifically, transmission device #4 updates the label information of the Resv message. In this process, label value corresponding to a path from transmission device #3 to transmission device #4 is given to the label information.

In addition to the update of the label information, transmission device #4 processes the RRO of the Resv message. Specifically, transmission device #4 decides whether or not node information is added to the received Resv message. In this example, node information “E(Z)” is added to the Resv message transmitted from transmission device #5. Also, transmission device #4 decides whether or not cooperative operations between the packet layer switch and the optical layer switch can be performed in transmission device #4. In this example, transmission device #4 is provided with optical layer switch Y, and cooperative operations between the optical layer switch D and the optical layer switch Y can be performed in transmission device #4. Further, transmission device #4 decides whether or not a connection can be established between the optical layer switch of transmission device #4 and an optical layer switch of the node that is adjacent to transmission device #4 on the upstream side. In this example, it is assumed that a connection can be established between optical layer switch Y in transmission device #4 and optical layer switch X in transmission device #3. In such a case, without updating the RRO, transmission device #4 transmits a Resv message to which node information “E(Z)” is added to transmission device #3.

(5) The operations of transmission device #3 are substantially the same as those of transmission device #4. Specifically, transmission device #3 transmits a Resv message to transmission device #2. For this transmission, node information “E(Z)” is added to the Resv message.

By (2) through (5) above, the Resv message transmitted from transmission device #6 is forwarded to transmission device #2. As a result, establishing of the path in the packet layer between transmission device #1 and transmission device #6 has been completed in the transmission devices located between transmission device #2 and transmission device #6 (i.e., transmission devices #3 through #5).

(6) Upon receiving the Resv message from transmission device #3, transmission device #2 executes a process similar to those executed by transmission device #3 through transmission device #5. Specifically, transmission device #2 decides whether or not node information is added to the received Resv message. In this example, node information “E(Z)” is added to a Resv message transmitted from transmission device #3. Also, transmission device #2 decides whether or not cooperative operations between the packet layer switch and the optical layer switch can be performed in transmission device #2. In this example, transmission device #2 is provided with optical layer switch W, and cooperative operations between packet layer switch B and optical layer switch W can be performed in transmission device #2. Further, transmission device #2 decides whether or not a connection can be established between the optical layer switch of transmission device #2 and an optical layer switch of the node that is adjacent to transmission device #2 on the upstream side. However, transmission device #1 is not provided with an optical layer switch, and accordingly a connection cannot be established between transmission device #2 and the node that is adjacent to transmission device #2 on the upstream side. In such a case, transmission device #2 executes a process of establishing a connection in the optical layer between transmission device #2 and a node represented by node information that is added to the received Resv message. In this example, node information “E(Z)” is added to the received Resv message. Accordingly, transmission device #2 starts a process of establishing a connection in the optical layer between transmission device #2 and transmission device #5.

Transmission device #2 generates a message (referred to as Path message hereinafter) for establishing a connection in the optical layer (OTN path for example) between transmission device #2 and transmission device #5. A connection in the optical layer is established by for example specifying input ports and output ports of the respective transmission devices located between the head end node and the tail end node. In such a case, a Path message requests assignment of a port number. Transmission device #2 transmits this Path message toward transmission device #5. Then, this Path message is forwarded to transmission device #5 via transmission device #3 and transmission device #4.

Also, transmission device #2 transmits, to transmission device #5, a message (referred to as a PathTear message hereinafter) for cancelling the path previously established in the packet layer between transmission device #2 and transmission device #5. This PathTear message is also forwarded to transmission device #5 via transmission device #3 and transmission device #4.

(7) Transmission device #3 forwards a Path message and a PathTear message to transmission device #4. Note that transmission device #3 cancels the setting of packet layer switch C in accordance with the PathTear message.

(8) Transmission device #4 forwards the Path message and the PathTear message to transmission device #5. Note that transmission device #4 cancels the setting of packet layer switch D in accordance with the PathTear message.

(9) Transmission device #5 transmits, toward transmission device #2, a Resv message corresponding to the Path message transmitted from transmission device #2. This Resv message includes information representing the port number corresponding to a connection from transmission device #4 to transmission device #5. In addition, transmission device #5 terminates the received PathTear message.

(10) Transmission device #4 forwards the Resv message to transmission device #3. When the Resv message is forwarded, transmission device #4 sets the operation mode of optical layer switch Y in accordance with the Resv message. For example, optical layer switch Y is configured to “forward an OTN frame received from transmission device #3 to transmission device #5 without guiding the message to the packet layer”.

(11) Transmission device #3 forwards the Resv message to transmission device #2. When the message is forwarded, transmission device #3 sets the operation mode of optical layer switch X in accordance with the Resv message. For example, optical layer switch X is configured to “forward an OTN frame received from transmission device #2 to transmission device #4 without guiding the message to the packet layer”. The Resv message transmitted from transmission device #5 is terminated by transmission device #2.

As described above, by establishing a connection in the optical layer between transmission device #2 and transmission device #5, an FA-LSP (Forwarding Adjacency-Label Switched Path) is established. As a result of this, transmission device #2 and transmission device #5 become adjacent to each other in the packet layer.

(12) and (13) Transmission device #2 conducts signaling of the packet layer again. Specifically, transmission device #2 transmits a Path message to transmission device #6. Then transmission device #6 transmits a Resv message to transmission device #1. At that moment, signaling in the optical layer has already been completed between transmission device #2 and transmission device #5. Accordingly, the transmission devices located between transmission device #2 and transmission device #5 (i.e., transmission device #3 and transmission device #4) do not execute the label process in the signaling of procedures (12) and (13).

As described above, according to the path establishing method of the first embodiment, a node for which an optical layer connection can be established is searched in the signaling process in the packet layer. The search result is reported to respective transmission device by using a signaling message in the packet layer. Then, in accordance with the search result, the signaling in the optical layer is conducted so that the optical layer connection is established for cutting through part of a path in the packet layer. In other words, a path with smaller transmission delay can be established automatically.

In the example illustrated in FIG. 3, a path in the packet layer is established between nodes #1 and #6, and an optical layer connection (FA-LSP) is established between nodes #2 and #5. Accordingly, data transmitted from node #1 to node #6 is forwarded in the optical layer without being processed in the packet layer. In other words, this data is transmitted from node #1 to node #6 without processed by packet layer switch C in node #3 and packet layer switch D in node #4.

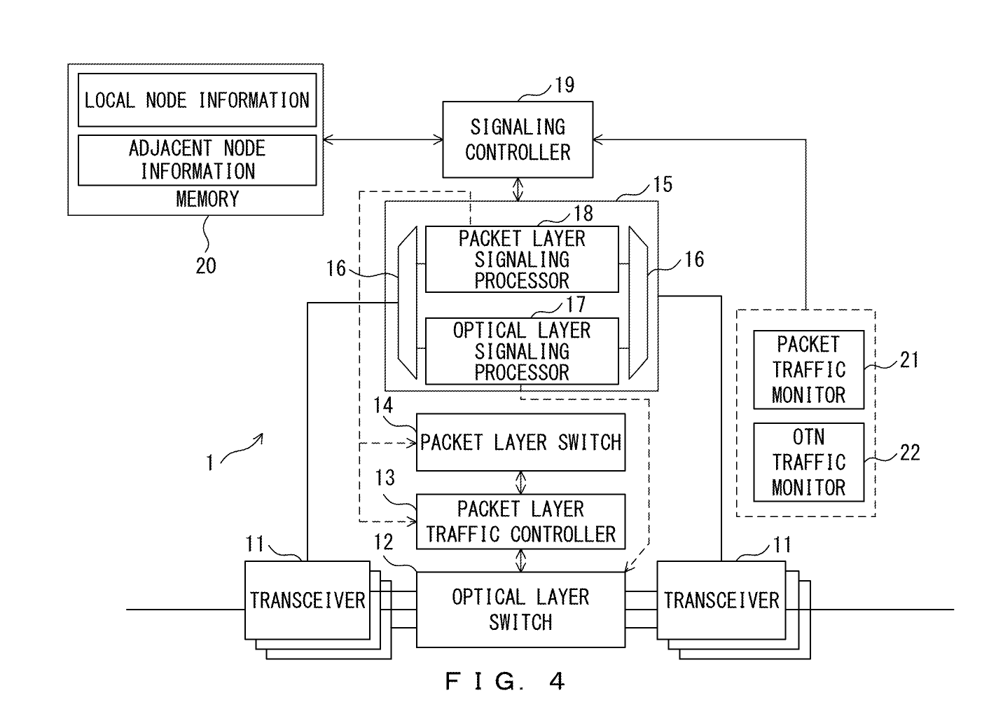

FIG. 4 illustrates an example of a configuration of a transmission device. A transmission device 1 includes a transceiver 11, an optical layer switch 12, a packet layer traffic controller 13, a packet layer switch 14, a signaling circuit 15, a signaling controller 19, a memory 20, a packet traffic monitor 21 and an OTN traffic monitor 22 as illustrated in FIG. 4.

The transceiver 11 guides a signal (OTN frame in this example) received from an adjacent node to the optical layer switch 12. However, when a received signal includes a signaling message, the transceiver 11 extracts a signaling message from the received signal and guides the message to the signaling circuit 15. The transceiver 11 transmits a signal output from the optical layer switch 12 to an adjacent node. The transceiver 11 may transmit a signaling message output from the signaling circuit 15 to an adjacent node. Note that the transmission device 1 may include a plurality of transceivers 11. The transceiver 11 is provided for example for each adjacent node. In such a case, the transceivers 11 may be identified by the port numbers of the optical layer switch 12.

The optical layer switch 12 conducts switching of an OTN frame. Switching conducted by the optical layer switch 12 is in accordance with an instruction from an optical layer signaling processor 17. In other words, the optical layer switch 12 provides an optical layer connection specified by the optical layer signaling processor 17. Note that the optical layer switch 12 includes a buffer memory that temporarily stores an OTN frame.

The packet layer traffic controller 13 extracts an OTN frame stored in the buffer memory in the optical layer switch 12, and divides the frame into packets so as to guide the packets to the packet layer switch 14. The packet layer traffic controller 13 stores packets processed by the packet layer switch 14 in an OTN frame, and guides the OTN frame to the optical layer switch 12. However, when a cut-through instruction is given from a packet layer signaling processor 18, the packet layer traffic controller 13 does not extract an OTN frame from the buffer memory of the optical layer switch 12. In other words, the packet layer traffic controller 13 can stop the cooperative operations between the optical layer switch 12 and packet layer switch 14.

The packet layer switch 14 conducts switching of packets. Switching conducted by the packet layer switch 14 is in accordance with an instruction from the packet layer signaling processor 18. In other words, the packet layer switch 14 provides a packet layer path specified by the packet layer signaling processor 18.

The signaling circuit 15 includes a separator/combiner 16, the optical layer signaling processor and the packet layer signaling processor 18. The separator/combiner 16 guides a signaling message received by the transceiver 11 to the optical layer signaling processor 17 or the packet layer signaling processor 18. The separator/combiner 16 guides a signaling message generated by the optical layer signaling processor 17 and the packet layer signaling processor 18 to the transceiver 11.

The optical layer signaling processor 17 conducts signaling for establishing or cancelling a connection in the optical layer. The packet layer signaling processor 18 conducts signaling for establishing or cancelling a path in the packet layer. The optical layer signaling processor 17 and the packet layer signaling processor 18 may establish or cancel a connection/path by using a known signaling protocol (RSVP for example).

The signaling controller 19 executes a process related to “cut-through” of a packet-layer path by using local node information and adjacent node information stored in the memory 20. Local node information includes information representing whether or not cooperation between the packet layer and the optical layer can be performed in the transmission device 1. Adjacent node information includes information representing an adjacent node that includes an optical layer switch connected to the optical layer switch 12 of the transmission node 1. The local node information and the adjacent node information are given to each transmission device for example by a network administrator in advance. Then, the signaling controller 19 controls the optical layer signaling processor 17 and the packet layer signaling processor 18 in a process of generating a cut-through connection.

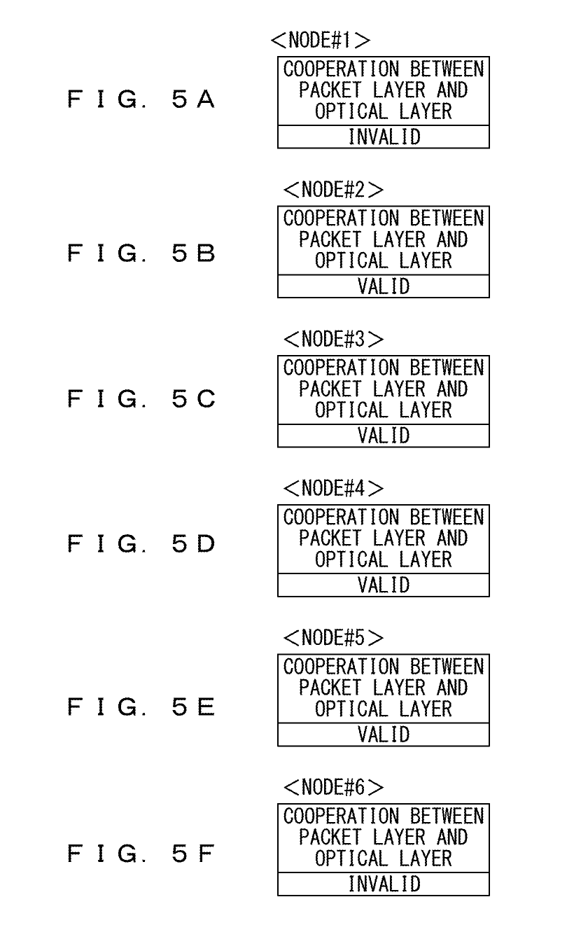

FIGS. 5A-5F illustrate examples of node information of their own nodes (local node information). FIGS. 5A-5F represent the local node information given to transmission devices #1 through #6 illustrated in FIG. 3. For example, transmission devices #1 and #6 do not include an optical layer switch, and are not capable of providing cooperation between the packet layer and the optical layer. Accordingly, “invalid” is given as the local node information to transmission devices #1 and #6. Transmission devices #2 through #5 are respectively provided with optical layer switches, and can provide cooperation between the packet layer and the optical layer. Accordingly, “valid” is given as the local node information to transmission devices #2 through #5.

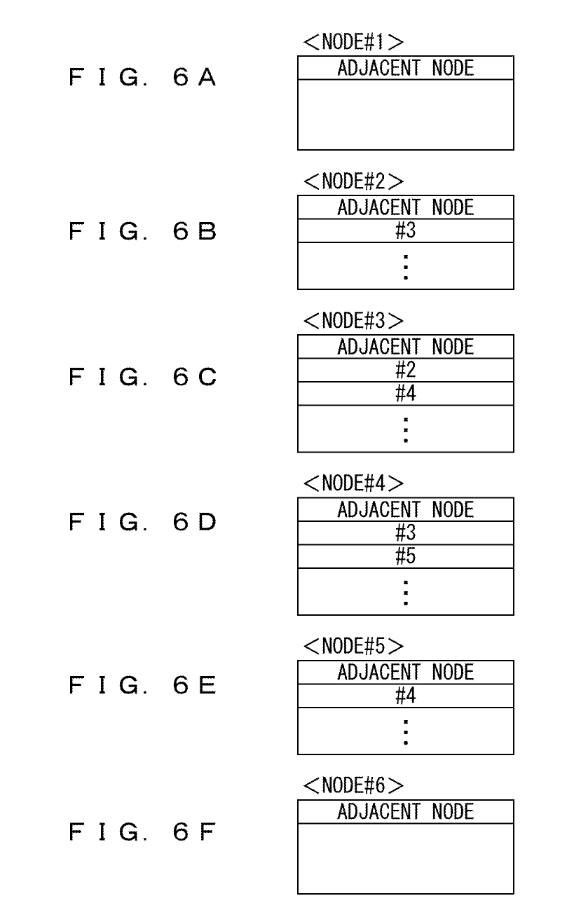

FIGS. 6A-6F illustrate examples of adjacent node information. FIGS. 6A-6F represent the adjacent node information given to transmission devices #1 through #6 illustrated in FIG. 3. For example, the optical layer switch 12 in transmission device #2 is connected to the optical layer switch of transmission device #3, and can establish an optical layer connection between nodes #2 and #3. Accordingly, the adjacent node information given to transmission device #2 includes “#3”. Similarly, the optical layer switch 12 in transmission device #3 is connected to the optical layer switch of transmission device #2 and the optical layer switch of transmission device #4, and can establish optical layer connections between nodes #2 and #3 and between nodes #3 and #4. Accordingly, the adjacent node information given to transmission device #3 includes “#2” and “#4”.

The packet traffic monitor 21 monitors packet traffic for each packet layer path. The OTN traffic monitor 22 monitors the OTN traffic for each optical layer connection.

Note that the optical layer signaling processor 17, the packet layer signaling processor 18 and the signaling controller 19 may be implemented by a processor that executes a program in which a signaling protocol is described. In such a case, the optical layer signaling processor 17, the packet layer signaling processor 18 and the signaling controller 19 may be implemented by one processor or may also be implemented by a plurality of processors. In addition, part of the functions of the optical layer signaling processor 17, the packet layer signaling processor 18 and the signaling controller 19 may be implemented by a hardware circuit.

Note that the transmission device 1 may receive a packet not via the optical layer switch 12 although this configuration is omitted in FIG. 4. For example, transmission device #2 may receive a packet from the transmission device 1.

In the transmission device 1 illustrated in FIG. 4, the signaling controller 19 may add node information to a Resv message used in signaling in the packet layer. The signaling controller 19 can activate the optical layer signaling processor 17 in accordance with the node information that is added to a received Resv message. In this process, the signaling controller 19 feds the node information obtained from the Resv message to the optical layer signaling processor 17. The optical layer signaling processor 17 transmits a message for establishing a connection in the optical layer to the node represented by the node information.

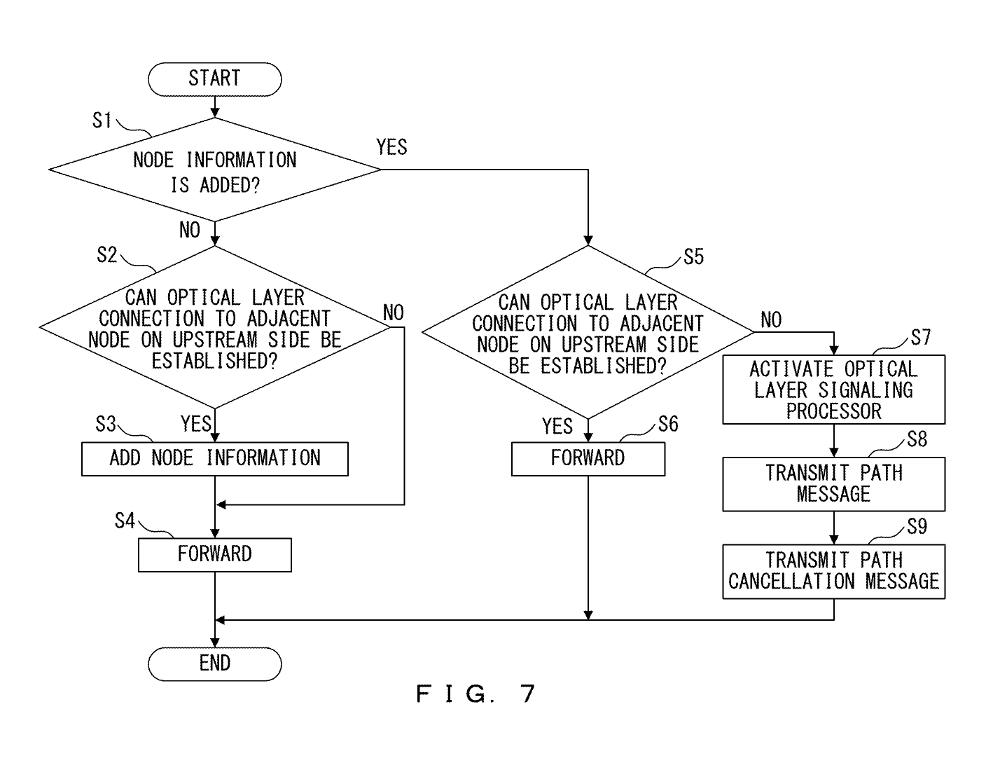

FIG. 7 is a flowchart illustrating an example of a process of a transmission device of the first embodiment. The process of this flowchart is performed by a transmission device that receives a Resv message in a signaling sequence in which a Path message is transmitted from the head end node to the tail end node and a Resv message is transmitted from the tail end node to the head end node. Note that the general process for establishing a path (label process etc. for example) and so on is omitted in FIG. 7.

In S1, the signaling controller 19 decides whether or not node information is added to the Resv message. Node information can be stored in the RRO in a Resv message. When node information is been added to the Resv message, the signaling controller 19 decides in S2 whether or not an optical layer connection can be established to an adjacent node on the upstream side. When the adjacent node on the upstream side is registered in the adjacent node information, it is decided that an optical layer connection can be established to the adjacent node on the upstream side.

When an optical layer connection can be established to the adjacent node on the upstream side, the signaling controller 19 adds node information to the Resv message in S3. In such a case, the node information representing the node itself is added to the Resv message. Node information may be stored in the RRO of the Resv message. When an optical layer connection cannot be established to the adjacent node on the upstream side, the process in S3 is skipped. Thereafter, the packet layer signaling processor 18 forwards the Resv message to the adjacent node on the upstream side in S4.

When node information is added to the Resv message (YES in S1), the signaling controller 19 decides in S5 whether or not an optical layer connection can be established to the adjacent node on the upstream side. Note that the process in S5 is substantially the same as the process in S2.

When an optical layer connection can be established to the adjacent node on the upstream side, the packet layer signaling processor 18 forwards the Resv message to the adjacent node on the upstream side in S6. When an optical layer connection cannot be established to the adjacent node on the upstream side, the processes in S7 through S9 are executed.

In S7, the signaling controller 19 activates the optical layer signaling processor 17. Then the signaling controller 19 specifies an end point node of the FA-LSP (Forwarding Adjacency-Label Switched Path) based on the node information added to the received Resv message, and reports the specified end point node to the optical layer signaling processor 17 and the packet layer signaling processor 18.

In S8, the optical layer signaling processor 17 transmits a Path message toward the endpoint node of the FA-LSP. This message requests the establishing of an optical layer connection. In S9, the packet layer signaling processor 18 transmits a PathTear message toward the end point node of the FA-LSP. This message requests the cancellation of a path in the packet layer.

Next, the process in the flowchart illustrated in FIG. 7 will be explained by referring to the example illustrated in FIG. 3. Hereinafter, explanations will be given for the operations conducted by transmission device #2 through transmission device #5 when a Resv message is transmitted from transmission device #6 toward transmission device #1. Note that transmission device #6 transmits a Resv message to which node information is not added.

Transmission device #5 receives the Resv message from transmission device #6. Since node information is not added to the Resv message at that moment, the decision result in S1 is “NO”. In addition, as illustrated in FIG. 6E, since the node that is adjacent to transmission device #5 on the upstream side (i.e., node #4) is registered as adjacent node information, an optical layer connection can be established between transmission device #5 and transmission device #4. In other words, the decision result in S2 is “YES”. Accordingly, transmission device #5 adds node information “E(Z)” to the Resv message in S3. Then transmission device #5 transmits this Resv message to transmission device #4.

Transmission device #4 receives the Resv message from transmission device #5. Since node information “E(Z)” is added to the Resv message at that moment, the decision result in S1 is “YES”. In addition, as illustrated in FIG. 6D, since the node adjacent to transmission device #4 on the upstream side (i.e., node #3) is registered as adjacent node information, an optical layer connection can be established between transmission device #4 and transmission device #3. In other words, the decision result in S5 is “YES”. Accordingly, transmission device #4 forwards the Resv message to transmission device #3. The operation of transmission device #3 is substantially the same as that of transmission device #4, and explanations thereof will be omitted.

Transmission device #2 receives the Resv message from transmission device #3. Since node information “E(Z)” is added to the Resv message at that moment, the decision result in S1 is “YES”. However, as illustrated in FIG. 6B, since the node that is adjacent to transmission device #2 on the upstream side (i.e., node #1) is not registered as adjacent node information, an optical layer connection cannot be established between transmission device #2 and transmission device #1. In other words, the decision result in S5 is “NO”. In such a case, the optical layer signaling processor 17 is activated in transmission device #2. Then, the optical layer signaling processor 17 transmits a Path message to the node represented by the node information “E(Z)” (i.e., node #5, which is provided with optical layer switch Z) in S8. This Path message requests the establishing of an optical layer connection between nodes #2 and #5. In addition, the packet layer signaling processor transmits a path cancellation message to the node represented by the node information “E(Z)” (i.e., node #5, which is provided with packet layer switch E) in S9. This path cancellation message requests the cancellation of the path in the packet layer between nodes #2 and #5.

Note that the optical layer signaling processor 17 in transmission device #3 configures optical layer switch X in accordance with the Path message in S8 so that nodes #2 and #4 are connected. In addition, the packet layer signaling processor 18 in transmission device #3 cancels the setting of packet layer switch C in accordance with the path cancellation message in S9 and also gives a cut-through instruction to the packet layer traffic controller 13. Thereafter, the packet layer traffic controller 13 does not extract an OTN frame from optical layer switch X. In other words, the cooperation between the packet layer and the optical layer is disrupted in transmission device #3.

Similarly, the optical layer signaling processor 17 in transmission device #4 configures optical layer switch Y in accordance with the Path message in S8 so that nodes #3 and #5 are connected. In addition, the packet layer signaling processor 18 cancels the setting of packet layer switch D in accordance with the path cancellation message in S9 and also gives a cut-through instruction to the packet layer traffic controller 13. Thereafter, the packet layer traffic controller 13 does not extract an OTN frame from optical layer switch Y. In other words, the cooperation between the packet layer and the optical layer is also disrupted in transmission device #4.

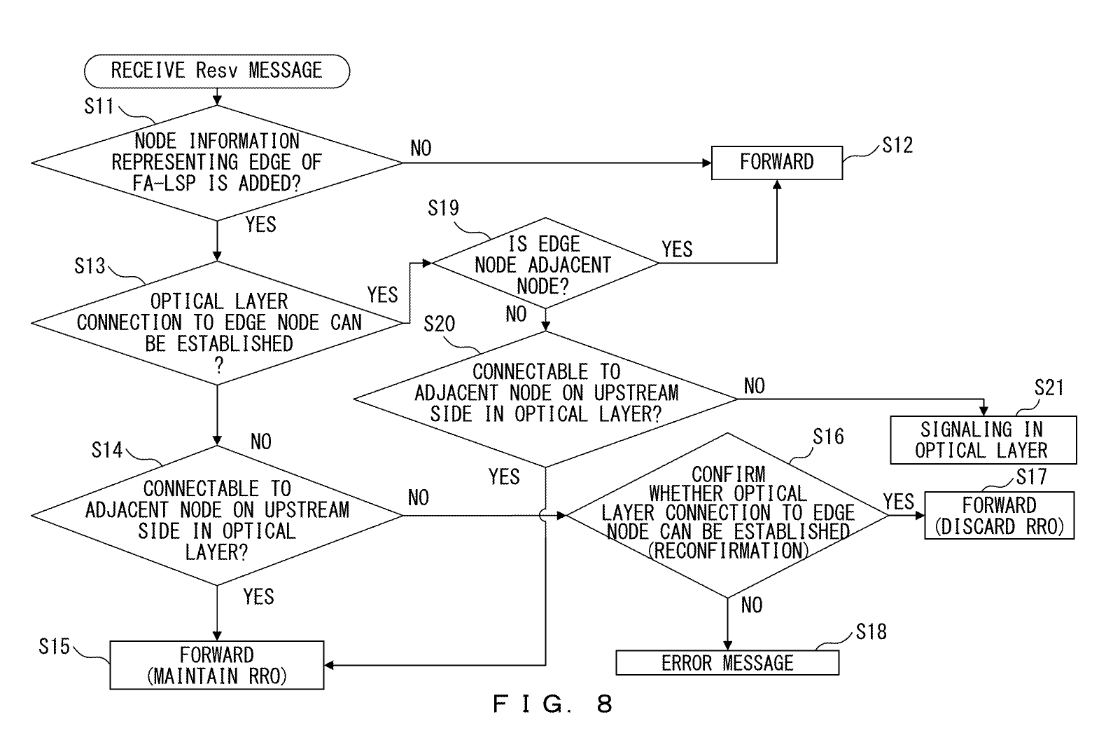

FIG. 8 is a flowchart illustrating another example of a process of a transmission device of the first embodiment. The process of this flowchart is also performed by a transmission device that receives a Resv message. Note that the general process for establishing a path (label process etc. for example) and so on is also omitted in FIG. 8.

In S11, the transmission device decides whether or not node information representing the edge of the FA-LSP is added to the Resv message. This node information represents a device in which the packet layer and the optical layer are cooperative. When node information representing the edge of the FA-LSP is not added to the Resv message, the transmission device forwards that Resv message to the upstream side in S12. In this transmission, when the RRO is stored in the Resv message, that RRO is discarded.

When node information representing the edge of the FA-LSP is added to the Resv message, the transmission device decides in S13 whether or not there exists registration indicating that an optical layer connection to the node represented by that node information (the edge node on the end point side) can be established. When there does not exist registration indicating that an optical layer connection to the edge node can be established, the transmission device decides in S14 whether or not a connection to the adjacent node on the upstream side can be established in the optical layer. When the connection to the adjacent node on the upstream side can be established in the optical layer, the transmission device forwards the received Resv message to the adjacent node on the upstream side in S15. For this transmission, the RRO in the Resv message is maintained.

When the connection to the adjacent node on the upstream side cannot be established in the optical layer (NO in S14), the transmission device confirms in S16 whether or not an optical layer connection can be established to the edge node. When an optical layer connection can be established to the edge node, the transmission device forwards the received Resv message to the adjacent node on the upstream side in S17. For this forwarding, the RRO of the Resv message is discarded. When an optical layer connection can be established to the edge node, the transmission device transmits in S18 an error message to the transmission device that generated the Path message.

When there is registration that an optical layer connection to the edge node can be established (YES in S13), the transmission device decides whether or not the edge node is an adjacent node in S19. When the edge node is an adjacent node, the transmission device forwards the Resv message to the upstream side in S12. When the edge node is not an adjacent node, the transmission device decides in S20 whether or not a connection to the adjacent node on the upstream side can be established in the optical layer. When a connection to the adjacent node on the upstream side can be established in the optical layer, the transmission device forwards in S15 the received Resv message to the adjacent node on the upstream side. When a connection to the adjacent node on the upstream side cannot be established in the optical layer, the transmission device starts the signaling in the optical layer in S21. In such a case, the transmission device transmits a message for establishing an optical layer connection toward the edge node.

As described above, according to the first embodiment, a node in which an optical layer connection can be established is searched for in a signaling sequence that is for establishing a path in the packet layer. When an optical layer connection can be established in a plurality of consecutive nodes, signaling for establishing an optical layer connection between the nodes that are at both ends of the plurality of consecutive nodes is executed. Accordingly, a path that cuts through switches in an upper layer can be automatically established in the multilayer network.

### Second Embodiment

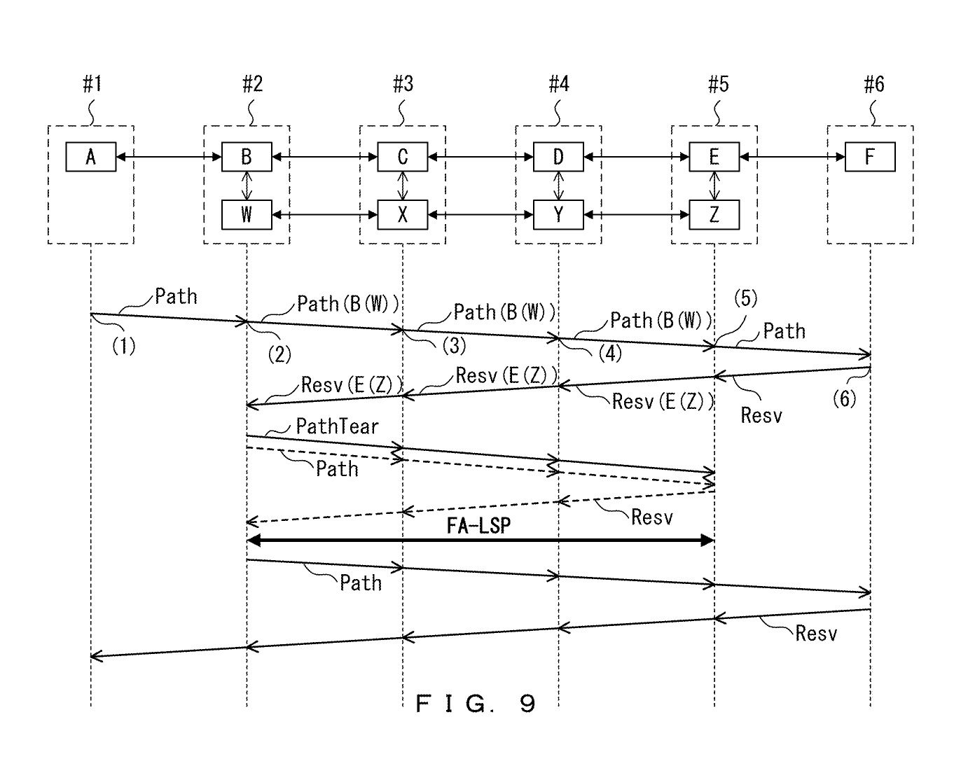

FIG. 9 illustrates an example of a path providing method according to the second embodiment of the present invention. The network configuration of the second embodiment is substantially the same as that of the first embodiment. Also, the configuration of transmission devices are substantially the same in the first and second embodiments.

According to the first embodiment, a Resv message, directed from the tail end node to the head end node, is utilized so that the connection status of the optical layer is reported to the respective nodes. According to the second embodiment, by contrast, a Path message, directed from the head end node to the tail end node, is utilized so that the connection status of the optical layer is reported to the respective nodes.

(1) Transmission device #1 starts the signaling of the packet layer. Specifically, transmission device #1 generates a Path message for establishing a path (LSP in this example) between transmission device #1 and transmission device #6. This Path message includes a label request (Label Request Object) and ERO (Explicit Route Object). The label request requests the assignment of a label. The ERO identifies a path from the head end node to the tail end node. In this example, “ERO=#2, #3, #4, #5, #6” is added to the Path message. Transmission device #1 transmits this Path message toward transmission device #6.

(2) Upon receiving the Path message from transmission device #1, transmission device #2 executes a process defined by RSVP-TE. Specifically, transmission device #2 deletes “#2” from the ERO of the Path message.

In addition to the update of ERO, transmission device #2 executes the following process. Specifically, transmission device #2 decides whether or not a flag is added to the received Path message. In this example, it is assumed that a flag is not added in the Path message transmitted from transmission device #1. Also, transmission device #2 decides whether or not cooperative operations between the packet layer switch and the optical layer switch can be performed in transmission device #2. In this example, transmission device #2 is provided with optical layer switch W, and cooperative operations between packet layer switch B and optical layer switch W can be performed in transmission device #2. Further, transmission device #2 decides whether or not a connection can be established between the optical layer switch of transmission device #2 and the optical layer switch of the node that is adjacent to transmission device #2 on the downstream side (i.e., on the side of the tail end node). In this example, a connection can be established between optical layer switch W in transmission device #2 and optical layer switch X in transmission device #3. In such a case, transmission device #2 adds, to the Path message, a flag indicating that cooperative operations between the packet layer switch and the optical layer switch can be performed in transmission device #2. Transmission device #2 includes packet layer switch B and optical layer switch W. Accordingly, the flag added to the Path message by transmission device #2 is referred to as “B(W)”. Note that the flag is set in for example the ERO, or may be added as a sub object that belongs to the ERO. Then, transmission device #2 transmits the Path message to transmission device #3.

(3) Upon receiving the Path message from transmission device #2, transmission device #3 executes a process defined by RSVP-TE. Specifically, transmission device #3 deletes “#3” from ERO of the Path message.

In addition to the update of the ERO, transmission device #3 executes the following processes. Specifically, transmission device #3 decides whether or not a flag is added to the received Path message. In this example, flag “B(W)” is added to the Path message transmitted from transmission device #2. Also, transmission device #3 decides whether or not cooperative operations between the packet layer switch and the optical layer switch can be performed in transmission device #3. In this example, transmission device #3 includes packet layer switch X, and cooperative operations between packet layer switch C and optical layer switch X can be performed in transmission device #3. Further, transmission device #3 decides whether or not a connection can be established between optical layer switch X in transmission device #3 and optical layer switch of the node that is adjacent to transmission device #3 on the downstream side. In this example, a connection can be established between optical layer switch X in transmission device #3 and optical layer switch Y in transmission device #4. In such a case, transmission device #3 forwards the received Path message to transmission device #4.

(4) The operations of transmission device #4 are substantially the same as that of transmission device #3. Specifically, transmission device #4 forwards the received Path message to transmission device #5. For this transmission, flag “B(W)” is set in the Path message.

(5) Similarly to transmission devices #3 and #4, transmission device #5 decides whether or not a flag is added to the received Path message. In this example, flag “B(W)” is added to the Path message transmitted from transmission device #4. Also, transmission device #5 decides whether or not cooperative operations between the packet layer switch and the optical layer switch can be performed in transmission device #5. In this example, transmission device #5 includes packet layer switch Z, and cooperative operations between packet layer switch E and optical layer switch Z can be performed in transmission device #5. Further, transmission device #5 decides whether or not a connection can be established between the optical layer switch of transmission device #5 and the optical layer switch of the node that is adjacent to transmission device #5 on the downstream side. However, transmission device #6 is not provided with an optical layer switch. In other words, transmission device #5 cannot establish an optical layer connection between nodes #5 and #6. In such a case, transmission device #5 deletes flag “B(W)” from the Path message and forward the message to transmission device #6.

Transmission device #5 receives the Path message to which flag “B(W)” is added, and thereby recognizes that an optical layer connection can be established between nodes #2 and #5. Specifically, transmission device #5 recognizes that it is possible to cut through packet layer switches between nodes #2 and #5.

(6) Transmission device #6 transmits, toward transmission device #1, a Resv message corresponding to the Path message transmitted from transmission device #1. This Resv message is substantially the same as that in the first embodiment.

The subsequent procedures are similar to those in the first embodiment. Specifically, transmission device #5 adds node information “E(Z)” to the Resv message. The Resv message to which node information “E(Z)” is added is forwarded to transmission device #2 via nodes #4 and #3. Then, transmission device #2 starts a process of establishing an optical layer connection between nodes #2 and #5 based on the node information.

In the second embodiment, however, the Path message to which flag “B(W)” is added is transmitted to node #5 from node #2 before the Resv message is transmitted. Transmission devices #3 and #4 respectively recognize that an optical later connection can be established on routes from node #2 to the nodes themselves according to the Path massage. Therefore, it is not necessary for transmission devices #3 and #4 to execute a reception process of messages when forwarding Resv messages to the upstream side.

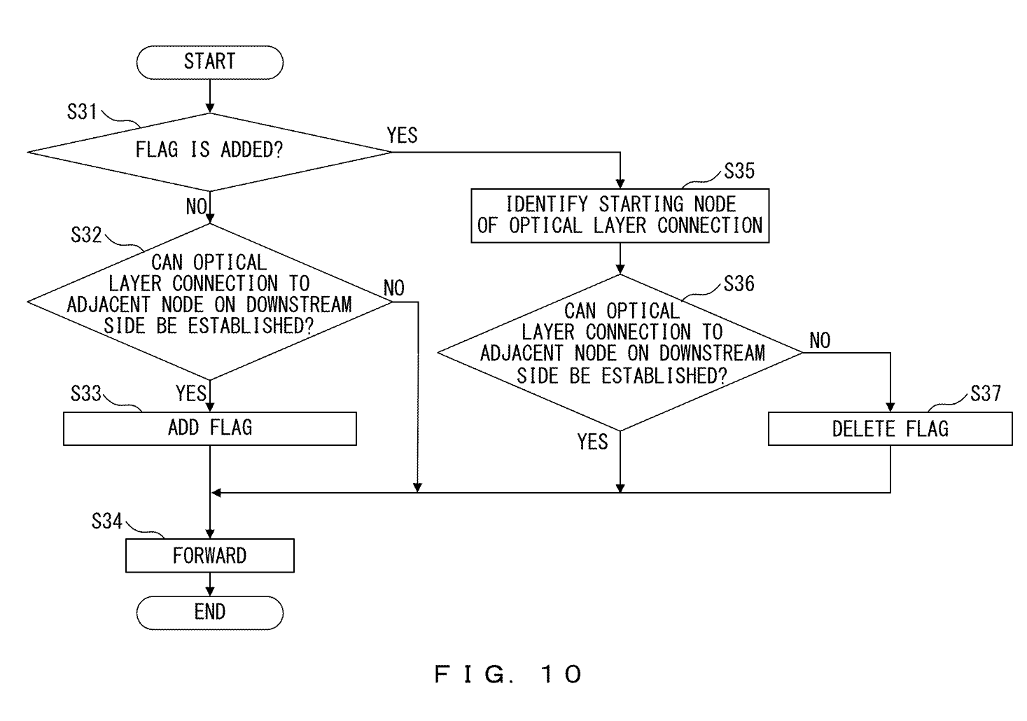

FIG. 10 is a flowchart illustrating an example of a process of a transmission device according to the second embodiment. This flowchart is executed by a transmission device that receives a Path message directed toward the tail end node from the head end node. Note that processes to be executed after forwarding a Path message are omitted in FIG. 10. The general process for establishing a path (process of updating the ERO etc. for example) and so on is also omitted in FIG. 10.

In S31, the signaling controller 19 decides whether or not a flag is added to a Path message. When a flag is not added to the Path message, the signaling controller 19 decides whether or not an optical layer connection can be established to the adjacent node on the downstream side. When the adjacent node on the downstream side is registered in the adjacent node information, it is decided that an optical layer connection can be established to the adjacent node on the downstream side.

When an optical layer connection can be established to the adjacent node on the downstream side, the signaling controller 19 adds a flag to the Path message in S33. In such a case, a flag representing the node itself is added to the Path message. The flag is set in for example the ERO of the Path message. When an optical layer connection cannot be established to the adjacent node on the downstream side, the process in S33 is skipped. Then, the packet layer signaling processor 18 forwards the Path message to the adjacent node on the downstream side in S34.

When a flag is added to the Path message (YES in S31), the signaling controller 19 identifies the starting node of the optical layer connection based on the value of that flag in S35. Next, the signaling controller 19 decides whether or not an optical layer connection can be established to the adjacent node on the downstream side in S36. Note that the process in S36 is substantially the same as that in S32.

When an optical layer connection can be established to the adjacent node on the downstream side, the packet layer signaling processor 18 forwards the Path message to the adjacent node on the downstream side. When an optical layer connection cannot be established to the adjacent node on the downstream side, the signaling controller 19 deletes the flag from the Path message in S37. Thereafter, the packet layer signaling processor 18 forwards the Path message to the adjacent node on the downstream side.

Next, explanations will be given to the process of the flowchart illustrated in FIG. 10 by referring to the example illustrated in FIG. 9. Hereinafter, the operations of transmission devices #2-#5 conducted when a Path message is transmitted from transmission device #1 toward transmission device #6 will be explained. Note that it is assumed that transmission device #1 transmits a Path message to which a flag is not added.

Transmission device #2 receives a Path message from transmission device #1. Since a flag is not added to the Path message at that moment, the decision result is “NO” in S31. Also, as illustrated in FIG. 6B, since the node that is adjacent to transmission device #2 on the downstream side (i.e., node #3) is registered as adjacent node information in transmission device #2, an optical layer connection can be established between transmission device #2 and transmission device #3. In other words, the decision result is YES in S32. Accordingly, transmission device #2 adds flag “B(W)” to the Path message in S33. Then, transmission device #2 forward this Path message to transmission device #3.

Transmission device #3 receives the Path message from transmission device #2. Since flag “B(W)” is added to the Path message at that moment, the decision result is YES in S31. Then, transmission device #3 recognizes in S35 that an optical layer connection can be established between transmission devices #2 and #3, and records starting node “#2”. Also, since the node that is adjacent to transmission device #3 on the downstream side (i.e., node #4) is registered as adjacent node information in transmission device #3, as illustrated in FIG. 6C, an optical layer connection can be established between transmission device #3 and transmission device #4. In other words, the decision result is YES in S36. Accordingly, transmission device #3 forwards the Path message to transmission device #4. The operation of transmission device #4 is substantially the same as that of transmission device #3 and explanations thereof will be omitted.

Transmission device #5 receives the Path message from transmission device #4. Since flag “B(W)” is added to the Path message at that moment, the decision result is YES in S31. Then, transmission device #5 recognizes in S35 that an optical layer connection can be established between nodes #2 and #5 and records starting node “#2”. However, since the node that is adjacent to transmission device #5 on the downstream side (i.e., node #6) is not registered as adjacent node information in transmission device #5, an optical layer connection cannot be established between transmission device #5 and transmission device #6. In other words, the decision result is “NO” in S36. In such a case, in S37, transmission device #5 deletes the flag from the Path message, and forwards the Path message to transmission device #6.

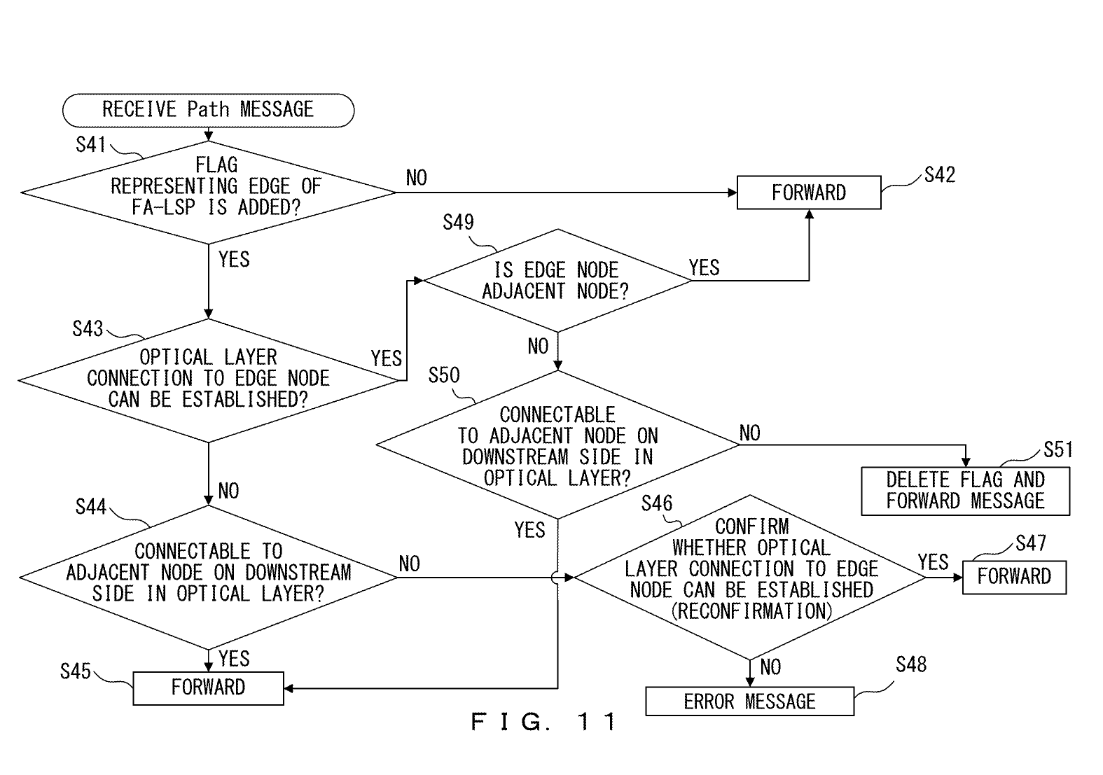

FIG. 11 is a flowchart illustrating another example of the process of a transmission device according to the second embodiment. This flowchart is also executed by a transmission device that receives a Path message. In FIG. 11 also, the general process for establishing a path (label process etc. for example) and so on is omitted.

In S41, a transmission device decides whether or not a flag representing the edge of the FA-LSP is added to the Path message. This flag represents a device in which the packet layer and the optical layer are cooperative. When a flag representing the edge of the FA-LSP is not added to the Path message, the transmission device forwards that Path message to the downstream side in S42.

When a flag representing the edge of the FA-LSP is added to the Path message, the transmission device decides in S43 whether or not there exists registration indicating that an optical layer connection can be established between the transmission device and the node represented by that flag (the edge node on the starting point side). When there does not exist registration indicating that an optical layer connection can be established between the transmission device and the edge node, the transmission device decides in S44 whether or not connection to the adjacent node on the downstream side can be established in the optical layer. When the connection to the adjacent node on the downstream side can be established in the optical layer, the transmission device forwards the received Path message to the adjacent node on the downstream side in S45.

When the connection to the adjacent node on the downstream side can be established in the optical layer (NO in S44), the transmission device confirms in S46 whether or not an optical layer connection can be established between the transmission device and the edge node. When an optical layer connection can be established between the transmission device and the edge node, the transmission device forwards the received Path message to the adjacent node on the downstream side in S47. When an optical layer connection cannot be established between the transmission device and the edge node, the transmission device transmits in S48 an error message to the transmission device that generated the Path message.

When there exists registration indicating that an optical layer connection can be established between the transmission device and the edge node (YES in S43), the transmission device decides whether or not the edge node is an adjacent node in S49. When the edge node is an adjacent node, the transmission device forwards the Path message to the downstream side in S42. When the edge node is not an adjacent node, the transmission device determines in S50 whether or not a connection to the adjacent node on the downstream side can be established in the optical layer. When the connection to the adjacent node on the downstream side can be established in the optical layer, the transmission device forwards the received Path message to the adjacent node on the downstream side in S45. When the connection to the adjacent node on the downstream side cannot be established in the optical layer, the transmission device deletes the flag in the Path message and forwards that Path message to the downstream side in S51.

As described above, according to the second embodiment, a node in which a path in a lower layer can be established is searched for by using a Path message directed toward the tail end node from the head end node, and the search result is reported to each node.

### Another Embodiment

According to the first and second embodiments, when a section in which a connection in a lower layer can be established is detected in signaling on an upper layer, signaling of the lower layer is activated, and a connection that cuts through a switch in the upper layer is established. However, the present invention is not limited to these embodiments. For example, it is also possible to configure cut through in a specified section.

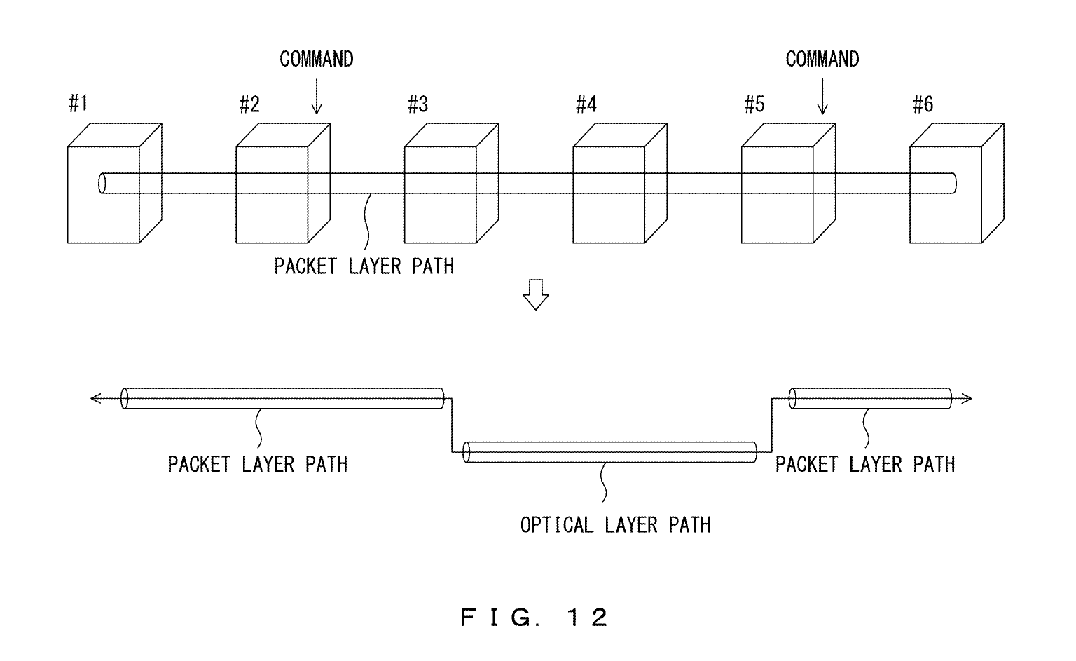

In the example illustrated in FIG. 12, a command for searching for a section that permits cut-through transmission between transmission device #2 and transmission device #5 is given. In such a case, signaling as illustrated in FIG. 3 is conducted between transmission device #2 and transmission device #5. Specifically, for example a Path message is transmitted from transmission device #2 to transmission device #5, and a Resv message is transmitted from transmission device #5 to transmission device #2. In the procedures of the signaling, a section in which an optical layer connection can be established is specified. In the example illustrated in FIG. 12, sections #3 through #5 is specified. In such a case, a path that does not use the packet layer switch of transmission device #4 is established.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmission device located between a first node and a second node in a multi-layer network in which a path message for establishing a path in an upper layer is transmitted from the first node to the second node and a response message corresponding to the path message is transmitted from the second node to the first node, the transmission device comprising:
an upper layer switch that processes traffic in the upper layer;
a lower layer switch that processes traffic in a lower layer; and
a signaling processor that processes the path message and the response message, wherein
the signaling processor adds node information representing a node at which the transmission device is provided to the response message received from an adjacent node on an downstream side and forwards the response message to an adjacent node on an upstream side when node information is not added to the received response message and the lower layer switch is connected to a lower layer switch of the adjacent node on an upstream side,
the signaling processor forwards the response message received from an adjacent node on a downstream side to an adjacent node on an upstream side when node information is added to the received response message and the lower layer switch is connected to a lower layer switch of the adjacent node on an upstream side, and
the signaling processor transmits a message for establishing a path in the lower layer to a node represented by node information added to the response message received from an adjacent node on a downstream side when the node information is added to the received response message and the lower layer switch is not connected to a lower layer switch of an adjacent node on an upstream side.

2. The transmission device according to claim 1, wherein
the signaling processor transmits a message for cancelling a path in the upper layer to a node represented by the node information added to the received response message when the node information is added to the received response message and the lower layer switch is not connected to a lower layer switch of the adjacent node on an upstream side.

3. The transmission device according to claim 1 further comprising
a storage in which an adjacent node that is connected to the lower layer switch via the lower layer is registered, wherein
the signaling processor decides that the lower layer switch is connected to a lower layer switch of an adjacent node on an upstream side when an adjacent node on an upstream side is registered in the storage, and decides that the lower layer switch is not connected to a lower layer switch of an adjacent node on an upstream side when an adjacent node on an upstream side is not registered in the storage.

4. A path establishing method for establishing a path between a first node and a second node by transmitting a path message for establishing a path in an upper layer from the first node to the second node and transmitting a response message corresponding to the path message from the second node to the first node, wherein
a first transmission device, that is located between the first node and the second node, adds node information representing the first transmission device to the response message received from an adjacent node of the first transmission device on a downstream side and forwards the response message to an adjacent node of the first transmission device on an upstream side when node information is not added to the response message and a path in a lower layer can be established between the first transmission device and the adjacent node on an upstream side, and
a second transmission device, that is located on an upstream side with respect to the first transmission device between the first node and the second node, transmit a message for establishing a path in the lower layer to the first transmission device represented by the node information added to the response message received from an adjacent node of the second transmission device on a downstream side when the node information is added to the received response message and a path in the lower layer cannot be established between the second transmission device and an adjacent node of the second transmission device on an upstream side.

5. The path establishing method according to claim 4, wherein
the second transmission device transmits a message for cancelling a path in the upper layer to the first transmission device.

6. A path establishing method for establishing a path between a first node and a second node in signaling sequence in a multi-layer network including an upper layer and a lower layer, the method comprising:
transmitting a signaling message for establishing a path in the upper layer between the first node and the second node;
deciding whether or not a path in the lower layer can be established in each node that receives the signaling message; and
executing signaling for establishing a path in the lower layer between nodes located at both ends of a plurality of consecutive nodes when it is decided that a path in the lower layer can be established in the plurality of consecutive nodes.

7. The path establishing method according to claim 6, wherein
the signaling message is a response message that corresponds to a path message for establishing a path in the upper layer transmitted from the first node to the second node and that is transmitted from the second node to the first node.

8. The path establishing method according to claim 6, wherein
the signaling message is a path message for establishing a path in the upper layer transmitted from the first node to the second node.
